(19) United States
(12) Patent Application Publication
(10) Pub. No.: US 2004/0082243 A1
(43) Pub. Date: Apr. 29, 2004

(54) Adhesive tapes comprising a textile support for enveloping elongated material, particularly looms of cables

(76) Inventor: Klaus Külper, (US)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/333,538

(22) PCT Filed: Aug. 7, 2001
(86) PCT No.: PCT/EP01/09091

(30) Foreign Application Priority Data
Aug. 16, 2000 (DE) 100 39 982.7

(51) Int. Cl. B32B 7/12

(52) U.S. Cl. 442/149; 428/343

(57) ABSTRACT

An adhesive tape for wrapping elongate product, especially cable harnesses, having a web-based backing provided on at least one side with an adhesive coating, said backing having a basis weight of from 20 to 80 g/m², in particular from 35 to 50 g/m², characterized in that the adhesive tape achieves a noise attenuation of from 3 to 10 dB(A), in particular from 4 to 6 dB(A) (measured in accordance with BMW Standard GS 95008-3 May 2000).

The invention relates to textile-backed adhesive tapes particularly suitable for wrapping elongate product, especially cable harnesses.

In modern-day vehicle construction, on the one hand the cable harnesses are becoming more and more bulky and thicker as a result of the multiplicity of electrical consumer units and the increased transfer of information within the vehicles, while on the other hand the space for installation is becoming evermore greatly restricted, and, consequently, the guidethrough possibilities when laying cables within the bodywork are becoming more problematic.

This development is paralleled by an increase in the comfort requirements. Flapping noises caused by cable harnesses, particularly in the vehicle interior, are to be avoided, and the aim is for soundproofing which is as effective as possible.

Furthermore, for efficient and cost-effective cable harness production, cable winding tapes are expected to be easy and quick to use.

Adhesive tapes based on unplasticized PVC films are used in automobiles for bandaging electrical lines to form cable harnesses. Although initially the prime purpose was to improve the electrical insulation when using these adhesive tapes, which were originally developed as insulating tapes, adhesive cable harness tapes of this type are now required to fulfill further functions, such as the bundling and permanent fixing of a multiplicity of individual cables to form a stable cable strand and to protect the individual cables against mechanical, thermal, and chemical attack.

While PVC-film adhesive tapes go a long way toward fulfilling protection against operating fluids such as fuels, oils, radiator fluids, etc., such as may typically occur in the vehicle, especially in the engine compartment, and while such tapes are advantageous on account of their inherent low flammability, the abrasion resistance and scuff resistance of such PVC-film adhesive tapes, however, is inadequate in many cases.

Moreover, PVC-film adhesive tapes fail to meet, or at least adequately to meet, the heightened requirements in respect of temperature stability and also soundproofing and protection against flapping.

As a result of more powerful engines and evermore close-packed installation of the components, the cable harness tapes are subject to increased requirements, which are reflected in long-term stabilities over 3000 h for 125° C. or more (general testing method, for example, in the case of Ford), which as far as unplasticized PVC is concerned can be achieved, if at all, only in exceptional cases, with special, expensive formulation.

The trends toward reducing cable harness cross sections are also reflected in the requirements that the copper cores within the cables be loaded with higher current strengths; as a result there is an increase in the temperature load, owing to increased ohmic heat production, for the cable insulation and also for the adhesive cable-harness tapes. Accordingly, this heightened requirement for improved temperature stability applies even in areas which are not in the immediate vicinity of the engine block.

The poor attenuation properties of cable strands wrapped with PVC-film adhesive tapes require the additional use, in exposed areas, of attenuating materials such as foam, felt, velour or the like, which represents an additional block of costs in terms both of the use of materials and of the processing outlay.

Not to be forgotten is the general concern, from environmental and toxicological standpoints, to eliminate completely the use of PVC material within the vehicle—in addition to the problems associated with the recycling of plastic material containing PVC, unplasticized PVC makes it more difficult to comply with the requirement to bring about a drastic reduction in the instances of outgassing from materials, particularly in the vehicle interior (known as “fogging value”, measured in accordance with DIN 75 201)—some of the slowly evaporating plasticizers, like DOP (dioctyl phthalate), have the drawback not only of a marked volatility but also of a known toxicological undesirability.

PVC-film adhesive tapes, on account of their low thickness, do particularly meet the requirement for low space occupancy, but are restricted in the extent to which they can be processed easily and comfortably. Manual cutting to length from the roll leads easily to overstretching of the PVC film and to a corrugated torn-off edge, which makes reliable final bonding more difficult. Moreover, the smooth surface of the film, under piece-work conditions in the course of manual cable winding, is not very friendly to the skin or fingers.

In contrast, PVC adhesive tapes are completely unsuitable in respect of soundproofing; in soundproofing tests such as those described, for example, under the item on “noise measurement” in the BMW Standard GS 95008-3 from May 2000, cable harnesses produced in this way have no measurable effect.

In this measurement method, a defined steel rod is wrapped with the test specimen and allowed to fall under specified conditions onto an aluminum panel. The resulting noise is detected and recorded by means of a microphone located above the test setup, in a frequency range from 20 to 12,500 Hz.

The attenuation is reported as the difference between the blank value, with the unwrapped steel rod, and the respective measurement, in dB(A).

WO 97/37839 describes a film adhesive tape which by virtue of a textured surface with grooves and ridges is said to exhibit soundproofing. In comparison with the smooth standard PVC adhesive tapes, however, no significant soundproofing is achieved in accordance with the measurement method described above.

Woven adhesive tapes, based in particular on polyester yarns or rayon yarns, are at about 0.3 mm, it is true, two or three times as thick as standard PVC film adhesive tapes with a thickness of predominantly 0.1 to 0.15 mm (all thicknesses determined in accordance with AFERA 4006 or ASTM D 1000 using a gauge with a diameter of 10 mm and an applied pressure of 51 kPA), but still exhibit only minimal soundproofing properties.

In order to obtain measurable and audible improvements, therefore, braided sleeves, self-adhesive foam materials or thick textiles such as velour and the like are used, particularly at critical points. These are usually expensive special parts for the cable harness, or complex multilayer systems, requiring labor-intensive application extra to the normal bandaging of the cables.

DE 199 10 730 A1 describes a laminate backing of this kind which is composed of velour or foam material and a nonwoven, bonded adhesively to one another by means of a double-sided adhesive tape or with a hotmelt adhesive.

DE 299 16 616 U1 describes a layer structure composed of a woven nylon velour fabric, additionally bonded firmly to a polymer coating made, for example, of polyacrylate or urethane.

EP 0 886 357 A2 describes a three-ply protective sheath comprising a spunbonded fiber web, a knitted PET fabric and a strip of foam material or of felt, which are laminated together, the protective sheath being additionally provided, at least partially and very expensively, with adhesive strips and touch-and-close fastener systems.

EP 1 000 992 A1 describes a perforated cotton nonwoven having a polyethylene coating from 10 to 45 μm in thickness plus a release coating.

Although all of said systems produce excellent noise proofing, at from 10 to 20 dB(A), they are nevertheless economically unacceptable or can be used only in particular problem zones and have thicknesses of usually 0.5 mm, in many cases even greater than 1.0 mm, as a result of which they produce a considerable increase in the space occupancy of cable harnesses equipped with them, thereby very severely restricting the possibilities for use.

In order to achieve pronounced soundproofing in the context of the standard bandaging of cables, in the form of a spiral winding, for some time nonwoven web backings have been used in adhesive tapes:

Accordingly, DE-U 94 01 037 describes an adhesive tape having a tapelike textile backing comprising a stitchbonded web formed in turn from a large number of stitches which have been sewn in and which run parallel to one another. On the basis of its special design, the adhesive tape described exhibits soundproofing properties in the course of its use for cable harness bandaging.

The web proposed herein is said to have a thickness of from 150 to 400 μm at a basis weight of from 50 to 200 g/m².

DE 44 42 092 C1 describes an adhesive tape, based on stitchbonded webs, which is coated on the reverse of the backing. Besides the stitchbonded web mentioned in the cited document, there are further backings used in adhesive tapes for cable harness bandaging. DE 44 42 093 C1 is based on the use of a web as backing for an adhesive tape, said web being a cross-laid fiber web which is reinforced by the formation of loops from the fibers of the web, i.e., a web known to the person skilled in the art by the name Malifleece. DE 44 42 507 C1 discloses an adhesive tape for cable bandaging, but bases it on so-called Kunit or Multiknit webs.

All three documents here use webs which have a basis weight of approximately 100 g/m², as is apparent from the examples. A web of this thickness is necessary in order to be able to reliably fulfill the set objectives.

DE 195 23 494 C1 discloses the use of an adhesive tape having a backing comprising web product for bandaging cable harnesses, said tape being coated on one side with an adhesive. The web employed in accordance with the invention is a polypropylene spunbonded web which is thermally consolidated and embossed with the aid of a calender, the embossing roll having an embossing area of from 10% to 30%, preferably 19%.

The web is described in advantageous embodiment, in which it has a basis weight of from 60 to 100 g/m², preferably 80 g/m², and a thickness of from 400 to 600 μm.

DE 298 04 431 U1 likewise discloses the use of an adhesive tape having a backing comprising web product for the bandaging of cable harnesses, the proposed spunbonded web being of polyester. The web is said to have a basis weight of from 60 to 100 g/m².

DE 298 19 014 U1 discloses adhesive tapes based on a web which is consolidated with jets of air and/or water.

DE 199 23 399 discloses an adhesive tape having a tapelike backing of web product, which is coated on at least one side with an adhesive, the web being a staple fiber web which is consolidated mechanically or is wet-laid. Between 2% and 50% of the fibers of the web are fusible fibers, specifically homopolymer, copolymer or bicomponent fibers having a relatively low softening or melting point.

It is mentioned by way of example that the fusible fibers of the web are of polypropylene, polyethylene, polyamide, polyester or copolymers.

The web disclosed is said to have the following properties:

a web weight of from 60 to 400 g/m², in particular 200 g/m²

a web thickness of from 100 μm to 3000 μm, in particular from 500 to 1000 μm.

Another adhesive tape having a tapelike backing of web product is disclosed in DE 199 37 446. The adhesive tape is coated on at least one side with an adhesive, the web being a staple fiber web which is consolidated mechanically or is wet-laid. Here, the further consolidation of the staple fiber web is accomplished by addition of binders, such as powders, films, meshes or binding fibers, for example. The binders may have been dissolved in water or organic solvent and/or may be present in dispersion form.

The binders are preferably employed as binder dispersions such as elastomers or such as thermosets in the form of phenolic or melamine resin dispersions, as dispersions of natural or synthetic rubbers, or as dispersions of thermoplastics such as acrylates, vinyl acetates, polyurethanes, styrene-butadiene systems, PVC, and copolymers thereof.

The web disclosed is said to have the following properties:

a web weight of from 50 to 500 g/m², in particular from 80 to 200 g/m²

a web thickness of from 100 μm to 3000 μm, in particular from 200 to 1000 μm.

WO 99/24518 A1 describes an adhesive tape where the backing product is a web which acquires its adhesive tape suitability only through the specific selection of fibers or filaments having a linear density of more than 15 denier and also through a film layer which is extruded on additionally.

The only webs achieving the objectives presented therein are those having a basis weight of from 34 to 678 g/m².

DE 197 32 958 A1 discloses an adhesive tape for wrapping elongate product, such as cable harnesses or plastic sections, which has a tapelike backing bounded by two lateral edges and provided on at least one side with a self-adhesive layer of a pressure-sensitive adhesive (PSA). The chemical composition of the PSA is such that, under gentle applied pressure on two adhesive layers lying one above the other, the interfaces dissolve and the adhesive layers coalesce completely to form a homogeneous PSA mass.

The invention depicted here also embraces a method of wrapping the elongate product. According to that method, the elongate product is positioned lengthways, in the region of a section of the adhesive tape, on a side of a tapelike backing of the adhesive tape that is provided with a self-adhesive layer, and then the adhesive tape is bonded in such a way that at least two adhesive regions of the tapelike backing are stuck to one another on the side provided with the adhesive layer in such a way that interfaces of the adhesive layer dissolve to form a homogeneous mass.

The result is therefore a pennant which protrudes from the wrapped product and which, especially under the restricted space conditions in automobile construction, is highly undesirable and harbors the potential risk that, when the cable harness is drawn through restricted apertures or passages, in the bodywork, for example, the wrapping will remain hanging and tear off, or at least the sheath will be damaged. This is to be avoided. Furthermore, it is continually emphasized that the only webs suitable are those provided with a basis weight of more than 100 g/m².

In actual fact, in the art, web backings with basis weights from 80 to 100 g/m² and significantly upward, and also thicknesses of 0.3 mm or more, are used, since in that case, with backings of that kind, a marked attenuation of noise occurs, particularly since it is known that such properties are dependent on the mass (weight) and volume (thickness) of the protective sheath. The heavier and thicker the backing, the greater the noise attenuation obtainable.

Using such adhesive tapes, noise reductions generally in the range from 3 to 10 dB(A), or even, in the case of thick web backings, such as the approximately 1 mm PES Malifleece of tesa 51606, 15 dB(A) or more (in each case measured in accordance with BMW Standard GS 95008-3 from May 2000) are achieved.

Adhesive tapes with such thick and heavy backing materials, however, especially when wound in an overlapping fashion, bulk up markedly and increase the space requirement for the cable harnesses. Moreover, they prevent efficient cable harness production, since owing to their thickness they can be wound only in short running lengths on rolls, which for processing on winding boards, however, must have only certain maximum diameters (in many cases approximately 100 mm).

Sections presented alternatively, in prefabricated form cut to length on release paper, necessitate an increased level of manual effort for removal of the release paper, which must subsequently be disposed of.

It is an object of the present invention to provide an adhesive tape which permits in particular the simple, inexpensive, and rapid wrapping of elongate product, which exhibits good attenuation properties, which has a low thickness and a low basis weight, so as to be employed even in restricted spaces, so that the disadvantages of the prior art do not occur, or at least not to the same extent.

This object is achieved by an adhesive tape as set out in the main claim. The subclaims relate to advantageous developments of the adhesive tape, and also preferred applications of the adhesive tape of the invention.

The invention accordingly provides an adhesive tape for wrapping elongate product, especially cable harnesses, having a web-based backing provided on at least one side with an adhesive coating, said backing having a basis weight of from 20 to 80 g/m², in particular from 20 to 60 g/m², very particularly from 35 to 50 g/m².

The adhesive tape achieves a noise attenuation of from 3 to 10 dB(A), in particular from 4 to 6 dB(A) (measured in accordance with BMW Standard GS 95008-3 from May 2000).

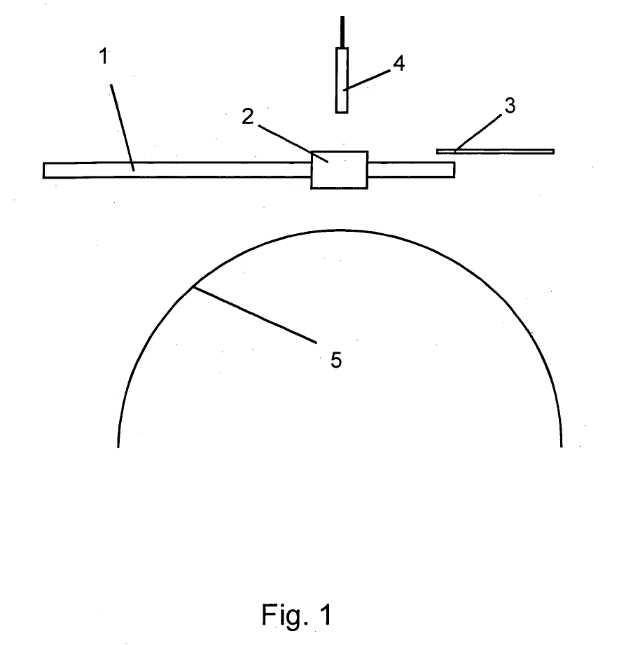

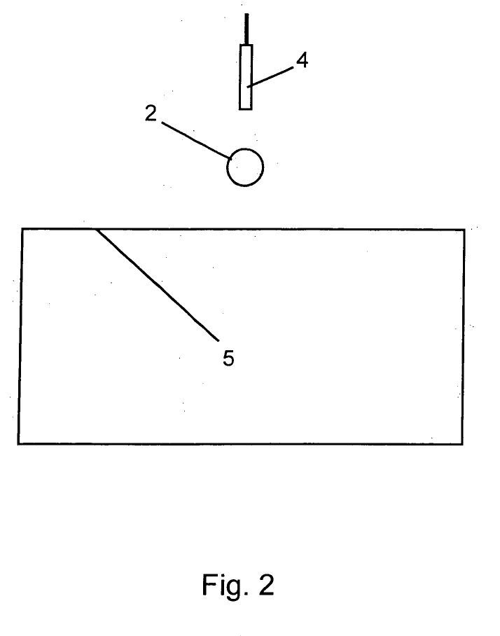

Disclosed again below, in conjunction with FIGS. 1 and 2, is the measurement technique of the BMW Standard GS 95008-3 from May 2000.

FIG. 1 shows the construction of the measuring apparatus, in side elevation, and

FIG. 2 shows the same construction in horizontal elevation.

In this measurement method a defined steel rod 1 with a diameter of 8 mm is wrapped with the test specimen 2—that is, adhesive tape—so as to give lever lengths of 220 mm and 150 mm. The wrapped steel rod 1 is [lacuna] to the height of drop, up to the stop 3, and caused to fall with a weight of approximately 16 g onto an aluminum panel 5. The aluminum panel 5, which in the nondeformed state measures 350×190×0.3 [mm], is arranged in the form of a half-barrel under the test specimen 2, so as to give an extent of 290 mm.

The overall resulting noise is detected and recorded by means of a microphone 4, located over the test setup, in a frequency range of, for example, 20 to 12,500 Hz using a commercially customary sound-measuring device, for example of type 2226 from Bruel & Kjaer. Particularly relevant for the human ear are frequencies in the range from 2000 to 5000 Hz.

The attenuation is reported as the difference between the blank value, with the unwrapped steel rod, and the respective measurement in dB(A).

Surprisingly, and unexpectedly for the skilled worker, even thin, lightweight web adhesive tapes are able to reach a noise attenuation of from 3 to 10 dB(A), in particular from 4 to 6 dB(A), with appropriate emphasis.

This property, which is very surprising given a low web-backing basis of weight of from 20 to 80 g/m², in particular from 20 to 60 g/m², very particularly from 35 to 50 g/m², allows the production of an innovative cable winding tape which can not only be applied thinly, like PVC film tapes, but also brings a significant weight saving as compared with existing film-based or woven-based winding tapes, and, in addition, takes account of the heightened requirements in respect of improved soundproofing.

As backing material for the adhesive tape it is possible to use all known nonwoven webs; the term “web” embraces at least textile sheetlike structures in accordance with EN 29092 (1988) and also stitchbonded nonwovens and similar systems.

Suitable nonwovens include, in particular, consolidated staple fiber webs, but also filament webs, meltblown webs, and spunbonded webs, which generally require additional consolidation. Known consolidation methods for webs are mechanical, thermal, and chemical consolidation. Whereas with mechanical consolidations the fibers can be held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Meyer, formerly Malimo, and can be obtained, inter alia, from the companies Naue Fasertechnik and Techtex GmbH. A Malifleece is characterized in that a cross-laid web is consolidated by the formation of loops from fibers of the web.

The backing used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced, inter alia, for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching.

Finally, stitchbonded webs are also suitable as an intermediate forming an enclosing cover of the invention and an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is preconsolidated mechanically in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from fibers of the web or by needling, stitching or air-jet or water-jet treatment.

In a second step, thermofixing takes place, with the strength of the web being increased again by the (partial) melting of the fusible fibers.

The web backing may also be consolidated without binders, by means for example of hot embossing with structured rollers, with properties such as strength, thickness, density, flexibility, and the like being controllable via the pressure, temperature, residence time, and embossing geometry.

For the inventive use of nonwovens, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in; as a sheet or as a mesh, or in the form of binding fibers. Liquid binders may be applied as solutions in water or organic solvent or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeugung” (Arbeitgeberkreis Gesamttextil, Eschborn, 1996).

For mechanically preconsolidated webs which already possess sufficient composite strength, the single-sided spray application of a binder is appropriate for effecting specific changes in the surface properties.

Such a procedure is not only sparing in its use of binder but also greatly reduces the energy requirement for drying. Since no squeeze rolls are required and the dispersions remain predominantly in the upper region of the web material, unwanted hardening and stiffening of the web can very largely be avoided.

For sufficient adhesive consolidation of the web backing, the addition of binder in the order of magnitude of from 1% to 50%, in particular from 3% to 20%, based on the weight the fiber web, is generally required.

The binder may be added as early as during the manufacture of the web, in the course of mechanical preconsolidation, or else in a separate process step, which may be carried out in-line or off-line. Following the addition of the binder it is necessary temporarily to generate a condition in which the binder becomes adhesive and adhesively connects the fibers—this may be achieved during the drying, for example, of dispersions, or else by heating, with further possibilities for variation existing by way of area or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process. It is advantageous that, as a result of the thermal treatment, volatile components such as fiber assistants are removed, giving a web having favorable fogging values, so that when a low-fogging adhesive is used it is possible to produce an adhesive tape having particularly advantageous fogging values; accordingly, even the enclosing cover has a very low fogging value as well.

A further, special form of adhesive consolidation consists in activating the binder by incipient dissolution or swelling. In this case it is also possible in principle for the fibers themselves, or admixed special fibers, to take over the function of the binder. Since, however, such solvents are objectionable on environmental grounds, and/or are problematic in their handling, for the majority of polymeric fibers, this process is not often employed.

Starting materials envisaged for the textile backing include, in particular, polyester, polypropylene, viscose or cotton fibers. The present invention is, however, not restricted to said materials; rather it is possible to use a large number of other fibers to produce the web, this being evident to the skilled worker without any need for inventive activity.

Low flammability in the adhesive tapes may be achieved by adding flame retardants to the web backing and/or to the adhesive. These retardants may be organobromine compounds, together where appropriate with synergists such as antimony trioxide; however, with a view to the absence of halogens from the adhesive tape, preference will be given to using red phosphorus, organophosphorus compounds, mineral compounds or intumescent compounds such as ammonium polyphosphate, alone or in conjunction with synergists.

To produce adhesive tapes, the backing material is coated on all or part of one side with adhesive, the coating technologies and the adhesives being in accordance with the prior art. As adhesives it is possible in principle to choose various polymer systems, with natural or synthetic rubber and also acrylate systems having proven particularly advantageous; silicone adhesives and other known self-adhesive compositions may likewise be employed for such applications provided their adhesion properties, temperature stabilities, compatibilities with the cable insulating material, etc. are in accordance with the requirements.

Particularly advantageous for the concept of the invention is a fogging-free self-adhesive tape comprising a fogging-free backing on at least one side of which there is applied a fogging-free, pressure-sensitive adhesive.

A suitable adhesive composition is one based on acrylate hot melt, having a K value of at least 20, in particular more than 30 (measured in each case in 1% strength by weight solution in toluene at 25° C.), obtainable by concentrating a solution of such a composition to give a system which can be processed as a hot melt. Concentrating may take place in appropriately equipped vessels or extruders; particularly in the case of accompanying devolatilization, a devolatilizing extruder is preferred.

An adhesive composition of this kind is set out in the German patent application DE 43 13 008 C2. In an intermediate step, the solvent is removed completely from these acrylate compositions prepared in this way.

The K value is determined in particular in analogy to DIN 53 726.

In addition, further volatile constituents are removed. After coating from the melt, these compositions contain only small fractions of volatile constituents. Accordingly, it is possible to adopt all of the monomers/formulations claimed in the above-cited patent. A further advantage of the compositions described in the patent is that they have a high K value and thus a high molecular weight. The skilled worker is aware that systems with higher molecular weights may be crosslinked more efficiently. Accordingly, there is a corresponding reduction in the fraction of volatile constituents.

The solution of the composition may contain from 5 to 80% by weight, in particular from 30 to 70% by weight, of solvent.

It is preferred to use commercially customary solvents, especially low-boiling hydrocarbons, ketones, alcohols and/or esters.

Preference is further given to using single-screw, twin-screw or multiscrew extruders having one or, in particular, two or more devolatilizing units.

The adhesive based on acrylate hotmelt may contain copolymerized benzoin derivatives, such as benzoin acrylate or benzoin methacrylate, for example, acrylates or methacrylates. Benzoin derivatives of this kind are described in EP 0 578 151 A.

The adhesive based on acrylate hotmelt may be UV-crosslinked. Other types of crosslinking, however, are also possible, an example being electron beam crosslinking.

In one particularly preferred embodiment, self-adhesive compositions used comprise copolymers of (meth)acrylic acid and esters thereof having from 1 to 25 carbon atoms, maleic, fumaric and/or itaconic acid and/or esters thereof, substituted (meth)acrylamides, maleic anhydride, and other vinyl compounds, such as vinyl esters, especially vinyl acetate, vinyl alcohols and/or vinyl ethers.

The residual solvent content should be below 1% by weight.

Owing in particular to the low basis weight and low thicknesses of the backing material, suitable coating techniques are those which are direct and place the adhesive onto the nonwoven virtually without pressure and, where appropriate, without contact, or else indirect coating techniques.

This not only prevents adhesive composition being pressed into the textile backing, and so being uselessly squandered for the subsequent bonding requirements, but also ensures that the open, textile structure, which provides for good breathing properties, suffers only minimal, if any, alteration.

Examples that may be mentioned here include not only the transferring of the adhesive from silicone release paper but also transfer by way of other temporary transfer media such as belts and the like and also pressureless adhesive coating by means of extrusion dies and the like, in which a fabricated film of adhesive composition is placed onto the web backing. Any improvement that may be necessary in the anchoring of the adhesive on the backing may be achieved, following coating of the adhesive, by applying temperature and/or pressure, in laminating stations, for example.

One possible indirect process for producing a flat, flexible backing coated with a porous film of adhesive is disclosed in DE 40 32 776 A1.

According to this process,

a) a flowable adhesive composition is applied to an interim backing which has the following properties:

under a light microscope or electron microscope it can be seen to have a corrugated, pleated, fissured or furrowed surface

the adhesive composition is readily detachable from its surface

it is substantially impermeable to air,

b) the microscopic air or solvent inclusions which form between the adhesive composition and the interim backing after the latter has been coated are expanded by temperature increase until the surface of the adhesive composition bursts open, and

c) the adhesive composition is then transferred from the interim backing to the final backing.

In contradistinction to the porous adhesive coating which is the aim of DE 40 32 776 A1, a very largely homogeneous, smooth, air-free and impervious adhesive coating is of advantage for the subject matter of this invention. If, however, a smooth and homogeneous surface of the interim backing is chosen instead of the textured surface above, these requirements can be met.

The base for the interim backing may be chosen from all common materials for such purposes. Particularly advantageous are woven belts of glass fiber, polyester, polyamide or Nomex®, a fiber material from DuPont. However, rubber cloths, polymer belts, and the like have also been found favorable. If fabric belts are chosen, it is advantageous to use those which have already been provided with a substantially unstructured surface coating of plastic. This latter coating promotes the adhesion and uniformity of the actual surface coating on the base. The surface coating itself ensures the desired easy transfer of the adhesive composition from the interim backing to the final backing. Advantageously, this interim backing surface is coated with an antiadhesive layer of, for example, crosslinked silicone rubber or fluoropolymers such as Teflon®.

A coating of this kind is found to be particularly advantageous if the state achieved is, so to speak, “frozen in” by chemical or physical methods and “cold flow” of the adhesive composition into the web backing is prevented by crosslinking. For example, the UV-crosslinkable acrylate hotmelts as sold by BASF under the commercial designation acResin© are particularly suitable for such requirements: after coating, a three-dimensional crosslinking takes place by means of UV radiation. Depending on the type of adhesive composition chosen, however, it is also possible to employ other types of crosslinking with advantage, such as chemical crosslinking, thermally initiated, and radiation-chemical crosslinking by means of electron beams, or other known systems.

In another preferred embodiment of the invention, the adhesive coating is applied to the web backing pressurelessly or indirectly at from 25 to 80 g/m², in particular from 30 to 50 g/m², and is then physically or chemically crosslinked.

Through the combination of the described specific coating of the backing with adhesive, and also the backing materials of the invention, an adhesive tape end product is obtained which in its overall basis weight weighs not more than 160 g/m², but in particular less than 120 g/m², very particularly, however, up to 100 g/m².

Accordingly it is possible, as compared with the existing adhesive tapes, to achieve a marked weight reduction, since these known commercial winding tapes almost without exception weigh more than 160 g/m², predominantly in fact from 180 to 200 g/m² and above, irrespective of whether they are PVC-film adhesive tapes or tapes based on woven or nonwoven fabric.

Since especially in the automobile industry considerable efforts are made to save weight wherever possible, in order, for example, to reduce fuel consumption and so to meet the administrative requirements relating to reducing carbon dioxide emission, an adhesive tape of this kind offers a further, additional advantage which is unachievable with the existing adhesive tapes.

The adhesive tape of the invention can be used with particular advantage for the spiral wrapping of an elongate product, such as a cable harness in particular. Here, all of the advantages of the adhesive tape are fully manifested.

As compared with plasticized PVC, the adhesive tapes of the invention have higher short-term and long-term temperature stabilities. Improved abrasion and scuff resistances along with markedly higher soundproofing predestine these adhesive tapes for use in particular bodywork areas.

Also prized is the ready possibility for manual processing in the production of cable harnesses. Easy manual tearability protects the limbs, muscles and ligaments of the normally female workforce against overexertion under piece-work conditions; a smooth torn edge without overstretch of the backing in the end region allows effective, reliable ending of winding without the risk of flagging; the soft, textile surface has proven to be skin-friendly for manual processing.

Adhesive tapes of this kind are not only PVC-free or halogen-free per se, and therefore meet the environmental requirements, but additionally, as a result of the specific construction of the backing from a multiplicity of individual fibers, there is also no need to use plasticizers and the like for the requisite flexibility of the backing—accordingly, it is possible on this basis to achieve favorable fogging values as compared with PVC-film adhesive tapes; that is, these web backings contribute levels of outgassing which are at least markedly reduced, if present at all.

The concept of the invention further embraces, therefore, an elongate product, especially a cable harness, wrapped with an adhesive tape of the invention.

The adhesive tape of the invention is described below in a preferred embodiment with reference to a number of examples, without thereby wishing to restrict the invention in any way whatsoever. Furthermore, a comparative example is given, which depicts an unfit adhesive tape.

### EXAMPLE 1

The backing chosen is a water-jet-consolidated nonwoven made from 100% polyester fibers with a linear density of 1.7 dtex, having a basis weight of 50 g/m² and a thickness of 0.4 mm, which is coated indirectly via silicone release paper, at 35 g/m², with a standard adhesive for cable harness applications, consisting of

40% by weight nature rubber,

48% by weight resins and plasticizers,

9% by weight zinc oxide filler, and

3% by weight carbon black and aging inhibitors.

The system is stabilized by crosslinking with electron beams in a dose of 70 kGy using an acceleration voltage of 200 kV.

When the noise attenuation is measured in accordance with BMW Standard GS 95008-3, the attenuation figure found for a winding tape produced in this way is 4.5 dB(A).

### EXAMPLE 2

A thermally consolidated web made of 100% polyester fibers, as available from Sandler under the designation “Sawabond 4342”, having a basis weight of 35 g/m², is coated in a transfer process, by way of a siliconized belt, with 40 g/m² of the acrylic hotmelt acResin 258 from BASF and the coating is crosslinked inline with a UV dose of 30 mJ/cm².

When the noise attenuation is measured, attenuation by 5 dB(A) as compared with the unwrapped steel rod is achieved.

### COUNTEREXAMPLE

A winding tape established over many years, based on a plasticized PVC film having a basis weight of 150 g/m² and a thickness of 0.11 mm, does not give any marked attenuation effect in the attenuation measurement, as compared with the unwrapped steel rod.

1. An adhesive tape for wrapping elongate product, especially cable harnesses, having a web-based backing provided on at least one side with an adhesive coating, said backing having a basis weight of from 20 to 80 g/m², in particular from 35 to 50 g/m², characterized in that the adhesive tape achieves a noise attenuation of from 3 to 10 dB(A), in particular from 4 to 6 dB(A) (measured in accordance with BMW Standard GS 95008-3 from May 2000).

2. An adhesive tape as claimed in claim 1, characterized in that the web constitutes a staple fiber web which is consolidated mechanically or wet-laid, the staple fiber web being further consolidated by the addition of binders and/or between 2% and 50% of the fibers of the web being fusible fibers.

3. An adhesive tape as claimed in claims 1 and 2, characterized in that the web is a spunbonded web or meltblown web made in particular of polypropylene or polyester which is thermally consolidated and embossed with the aid of a calender.

4. An adhesive tape as claimed in claims 1 to 3, characterized in that the web is consolidated by overstitching with separate threads or by interlooping.

5. An adhesive tape as claimed in claims 1 to 4, characterized in that the adhesive coating is applied to the web backing pressurelessly or indirectly at from 25 to 80 g/m², in particular from 30 to 50 g/m², and then is physically or chemically crosslinked.

6. An adhesive tape as claimed in claims 1 to 5, characterized in that the overall basis weight of the adhesive tape is not more than 160 g/m², in particular less than 130 g/m², very particularly, however, up to 100 g/m².

7. The use of an adhesive tape as claimed in at least one of the preceding claims for the spiral wrapping of an elongate product, such as a cable harness in particular.

8. An elongate product, especially a cable harness, wrapped with an adhesive tape as claimed in at least one of the preceding claims.
